(19) United States
(12) Patent Application Publication
(10) Pub. No.: US 2006/0232693 A1
(43) Pub. Date: Oct. 19, 2006

(54) Imaging device and digital camera

(76) Inventor: Ryohei Miyagawa, Kyoto-fu (JP)

Correspondence Address: PANASONIC PATENT CENTER;c/o MCDERMOTT WILL & EMERY LLP, 600 13TH STREET, NW, WASHINGTON, DC, 20005-3096, US

(21) Appl. No.: 11/388,210

(22) Filed: Mar. 24, 2006

(30) Foreign Application Priority Data
Mar. 25, 2005 (JP) 2005-089954

(51) Int. Cl. H04N 5/335; H04N 3/14

(52) U.S. Cl. 348/308

(57) ABSTRACT

To provide an imaging device having a multi-pixel cell MOS image sensor in which, even when a charge overflows to a detection part as a result that strong light falls on one photodiode and causes the photodiode to saturate, the overflowing charge can be prevented from leaking to another unsaturated photodiode. The imaging device includes a plurality of unit cells each of which includes N photodetectors, one detection part, N read transistors, one reset transistor, and one amplification transistor. Each read transistor switches ON and OFF between a corresponding photodetector and the detection part, thereby causing luminance information in the photodetector to be moved to the detection part. The reset transistor switches ON and OFF between a power supply terminal and the detection part. The amplification transistor amplifies the moved luminance information. Each of the N read transistors is an enhancement transistor, and the reset transistor is a depression transistor.

### BACKGROUND OF THE INVENTION

1. Field of the Invention

The present invention relates to an imaging device in which a plurality of unit cells for photoelectrically converting incident light are arranged one-dimensionally or two-dimensionally on a semiconductor substrate, and a digital camera having such an imaging device. The present invention in particular relates to techniques for eliminating a charge leakage between pixels, which is a problem specific to multi-pixel cell MOS image sensors.

2. Related Art

Imaging equipment such as a mobile phone with a built-in digital camera is widely used in recent years.

Power consumption of such imaging equipment needs to be reduced for weight saving and also for attaining long continuous use hours. Hence the imaging equipment typically uses a MOS image sensor that consumes much less power than a CCD image sensor.

One type of MOS image sensors is a multi-pixel cell type in which one cell corresponds to a plurality of pixels. This type reads signals from two or more photodiodes through corresponding read transistors, and feeds the read signals to one detection part.

Another type of MOS image sensors is not equipped with a row selection transistor, and instead selects a row in accordance with pulses applied to a reset transistor, a read transistor, and a power supply terminal. According to this construction, the number of transistors can be reduced, which contributes to a higher pixel density (see patent document 1 (Japanese Patent Application Publication No. 2003-46864) and patent document 2 (Japanese Patent Application Publication No. 2004-312472)).

Combining these two types, non-patent document 1 (IEEE Journal of Solid-State Circuits, Vol. 39, No. 12, December 2004, pp. 2417-2425, “A 3.9-μm Pixel Pitch VGA Format 10-b Digital Output CMOS Image Sensor With 1.5 Transistor/Pixel”) discloses a four-pixel cell MOS image sensor in which one reset transistor (M5) has both a row selection function and a reset function in each cell (see FIGS. 3 and 4 of non-patent document 1). According to this document, row selection can be performed by turning a reset transistor (M5) of a desired row ON while controlling a potential of an output signal line (see FIG. 4 of non-patent document 1), with it being possible to reduce the number of transistors and achieve a higher pixel density.

However, multi-pixel cell MOS image sensors have the following specific problem.

Note here that this specification mainly uses a two-pixel cell MOS image sensor as an example, for ease of explanation.

In a two-pixel cell MOS image sensor, when strong light falls on one photodiode and as a result the photodiode becomes saturated, a charge overflows from a corresponding read transistor to a detection part and further leaks to another photodiode which is unsaturated. This makes it impossible to correctly read a luminance signal.

In the case of a MOS image sensor having a row selection transistor, this problem can be overcome by allowing conduction between a source and a drain of a reset transistor to thereby reset a detection part, while blocking conduction between a source and a drain of a row selection transistor to thereby put a corresponding cell in an unselected state.

In the case of a MOS image sensor without a row selection transistor, however, this method cannot be used because resetting a detection part of an unselected cell while reading a charge from a detection part of a selected cell causes the unselected cell to become selected.

### SUMMARY OF THE INVENTION

In view of the above problem, the present invention aims to provide an imaging device having a multi-pixel cell MOS image sensor in which, even when a charge overflows to a detection part as a result that strong light falls on one photodiode and causes the photodiode to saturate, the overflowing charge can be prevented from leaking to another unsaturated photodiode. The present invention also aims to provide a digital camera equipped with such an imaging device.

The stated aim can be achieved by an imaging device including an arrangement of a plurality of unit cells each for storing luminance information corresponding to an amount of received light, each of the plurality of unit cells including: N photodiodes, N being an integer no less than 2; a detection part; N read transistors corresponding one-to-one to the N photodiodes, and each operable to switch between conducting and non-conducting states of a path between the corresponding photodiode and the detection part, thereby causing luminance information in the corresponding photodiode to be moved to the detection part; a reset transistor operable to switch between conducting and non-conducting states of a path between a power supply terminal and the detection part; and an amplification transistor operable to amplify the luminance information moved to the detection part, wherein each of the N read transistors is an enhancement transistor, and the reset transistor is a depression transistor.

The stated aim can also be achieved by a digital camera including this imaging device.

According to the above construction, an enhancement transistor is used as the read transistor, and a depression transistor is used as the reset transistor. This being so, even when a charge overflows to the detection part as a result that strong light falls on one photodiode and causes the photodiode to saturate, the overflowing charge can be prevented from leaking to another unsaturated photodiode because the charge is drained away before a potential of the detection part reaches 0 V.

In an imaging device having a row selection transistor, this construction eliminates the need to perform specific control such as resetting a detection part of an unselected cell using a reset transistor.

Here, amplification transistors of a predetermined number of unit cells may be connected to one common output line, wherein amplified luminance information in each of the predetermined number of unit cells is output to the common output line.

According to the above construction, despite that the imaging device is not equipped with a row selection transistor and therefore is unable to reset a detection part of an unselected cell while reading a charge from a detection part of a selected cell, the above charge leakage can be prevented.

The stated aim can also be achieved by an imaging device including an arrangement of a plurality of unit cells each for storing luminance information corresponding to an amount of received light, each of the plurality of unit cells including: N photodiodes, N being an integer no less than 2; a detection part; N read transistors corresponding one-to-one to the N photodiodes, and each operable to switch between conducting and non-conducting states of a path between the corresponding photodiode and the detection part, thereby causing luminance information in the corresponding photodiode to be moved to the detection part; a reset transistor operable to switch between conducting and non-conducting states of a path between a power supply terminal and the detection part; and an amplification transistor operable to amplify the luminance information moved to the detection part, wherein each of the N read transistors and the reset transistor is an enhancement transistor, and the imaging device further includes a bias circuit operable to apply a low bias voltage to a gate of the reset transistor.

The stated aim can also be achieved by a digital camera including this imaging device.

According to the above construction, the low bias voltage is applied to the gate of the reset transistor. In this way, even when a charge overflows to the detection part as a result that strong light falls on one photodiode and causes the photodiode to saturate, the overflowing charge can be prevented from leaking to another unsaturated photodiode because the charge is drained away before a potential of the detection part reaches 0 V.

In an imaging device equipped with a row selection transistor, this construction eliminates the need to perform specific control such as resetting a detection part of an unselected cell using a reset transistor.

Here, amplification transistors of a predetermined number of unit cells may be connected to one common output line, wherein amplified luminance information in each of the predetermined number of unit cells is output to the common output line.

According to the above construction, despite that the imaging device is not equipped with a row selection transistor and therefore is unable to reset a detection part of an unselected cell while reading a charge from a detection part of a selected cell, the above charge leakage can be prevented.

### BRIEF DESCRIPTION OF THE DRAWINGS

These and other objects, advantages and features of the invention will become apparent from the following description thereof taken in conjunction with the accompanying drawings which illustrate a specific embodiment of the invention.

In the drawings:

FIG. 1 shows a digital camera to which an embodiment of the present invention relates;

FIG. 2 shows a rough construction of a solid-state imaging device included in the digital camera shown in FIG. 1;

FIG. 3 schematically shows circuitry of the imaging device shown in FIG. 2;

FIG. 4 shows a state of a potential in each region in a pixel circuit shown in FIG. 3 at a predetermined timing, where incident light is not strong enough to cause saturation of any photodetector;

FIG. 5 shows a state of a potential in each region in the pixel circuit at a predetermined timing, where incident light is not strong enough to cause saturation of any photodetector;

FIG. 6 shows a state of a potential in each region in the pixel circuit at a predetermined timing, where incident light is not strong enough to cause saturation of any photodetector;

FIG. 7 shows a state of a potential in each region in the pixel circuit at a predetermined timing, where incident light is not strong enough to cause saturation of any photodetector;

FIG. 8 shows a state of a potential in each region in the pixel circuit at a predetermined timing, where incident light is not strong enough to cause saturation of any photodetector;

FIG. 9 shows a state of a potential in each region in the pixel circuit at a predetermined timing, where incident light is not strong enough to cause saturation of any photodetector;

FIG. 10 shows a state of a potential in each region in the pixel circuit at a predetermined timing, where incident light is not strong enough to cause saturation of any photodetector;

FIG. 11 shows a state of a potential in each region in the pixel circuit at the same timing as in FIG. 4, where incident light is strong enough to cause saturation of one photodetector; and

FIG. 12 schematically shows a low bias circuit which outputs a low bias voltage.

### DESCRIPTION OF THE PREFERRED EMBODIMENT(S)

### Embodiment

<Overview>

An embodiment of the present invention relates to an imaging device having a multi-pixel cell MOS image sensor in which an enhancement transistor is used as a read transistor and a depression transistor is used as a reset transistor, and a digital camera equipped with the imaging device. According to this construction, even when a charge overflows to a detection part as a result that strong light falls on one photodiode and causes the photodiode to saturate, the overflowing charge is kept from leaking to another unsaturated photodiode, since the charge is drained away before a potential of the detection part reaches 0 V.

<Construction>

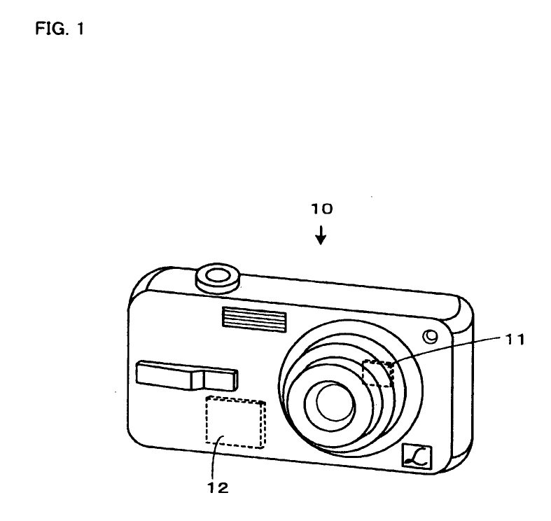

FIG. 1 shows a digital camera 10 to which the embodiment of the present invention relates.

The digital camera 10 is capable of taking a still picture, and includes a solid-state imaging device 11 and a drive device 12 as shown in FIG. 1.

The imaging device 11 is positioned where light passing through a light shielding device forms an image. The imaging device 11 is roughly made up of a semiconductor device where a plurality of unit cells each for outputting luminance information corresponding to an amount of received light are arranged, and peripheral circuitry of the semiconductor device.

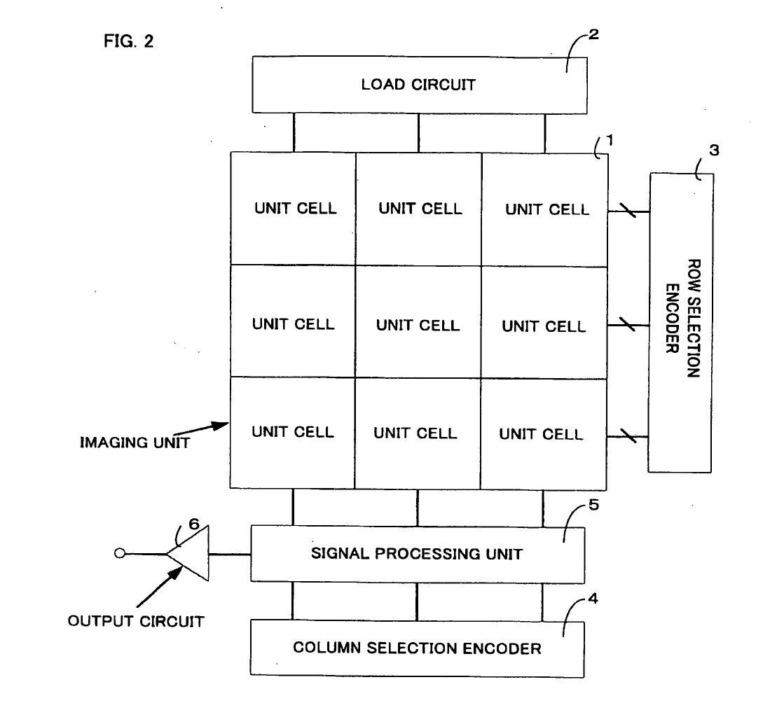

FIG. 2 shows a rough construction of the imaging device 11 to which the embodiment of the present invention relates.

As shown in the drawing, the imaging device 11 includes an imaging unit 1, a load circuit 2, a row selection encoder 3, a column selection encoder 4, a signal processing unit 5, and an output circuit 6.

The imaging unit 1 is an imaging area where a plurality of unit cells are arranged one-dimensionally or two-dimensionally. Though only 18 pixels that constitute 9 unit cells arranged in a 3×3 two-dimensional matrix are shown in the drawing, an actual number of pixels is about several thousands in one dimension, and several hundred thousands to several millions in two dimension.

The load circuit 2 has a plurality of identical circuits that are each connected to a different column of the imaging unit 1, and applies a load to pixels in the imaging unit 1 in units of columns, in order to read an output voltage.

The row selection encoder 3 has three control lines “RESET”, “READ1”, and “READ2” for each row of the imaging unit 1, and exercises control, such as reset (initialization), read 1, and read 2, on pixels in the imaging unit 1 in units of rows.

The column selection encoder 4 has control lines, and selects columns in sequence.

The signal processing unit 5 has a plurality of identical circuits that are each connected to a different column of the imaging unit 1. The signal processing unit 5 processes an output of the imaging unit 1 made in units of columns, and outputs the processed signal.

The output circuit 6 performs necessary conversion on the output of the signal processing unit 5, and outputs the converted signal to outside.

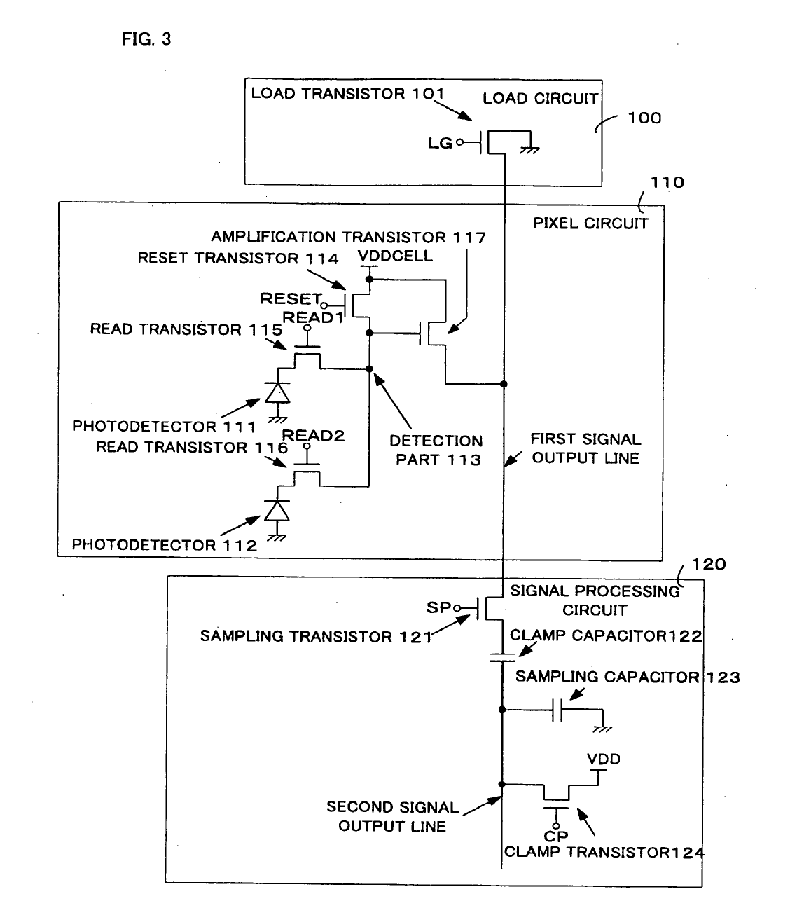

FIG. 3 schematically shows circuitry of the imaging device 11.

The circuitry of the imaging device 11 in FIG. 3 includes a load circuit 100, a pixel circuit 110, and a signal processing circuit 120.

The load circuit 100 represents one of the plurality of circuits in the load circuit 2 shown in FIG. 2. The load circuit 100 includes a load transistor 101 connected between a first signal output line and GND, and is supplied with a load voltage (LG).

The pixel circuit 110 represents one of the plurality of unit cells in the imaging unit 1 shown in FIG. 2. The pixel circuit 110 has a function of outputting a reset voltage, which is a result of amplifying a voltage at the time of initialization (i.e. an initial voltage), and a read voltage, which is a result of amplifying a voltage at the time of reading, to the first signal output line. The pixel circuit 110 includes photodetectors 111 and 112, a detection part 113, a reset transistor 114, read transistors 115 and 116, and an amplification transistor 117.

The photodetectors 111 and 112 are, for example, photodiodes each of which performs photoelectric conversion on incident light to generate a charge, accumulates the generated charge, and outputs the accumulated charge as a voltage signal (luminance information).

The detection part 113 accumulates the charge generated by the photodetector 111 or 112.

The reset transistor 114 resets a voltage of the detection part 113 to the initial voltage (VDD in this embodiment).

The read transistor 115 supplies the charge output from the photodetector 111, to the detection part 113.

The read transistor 116 supplies the charge output from the photodetector 112, to the detection part 113.

The amplification transistor 117 outputs a voltage that varies according to the voltage of the detection part 113.

VDDCELL is a power supply terminal that periodically alternates between a Hi potential (VDD) and a Lo potential (GND).

It should be noted here that the read transistors 115 and 116 are enhancement transistors, and the reset transistor 114 is a depression transistor.

The signal processing circuit 120 represents one of the plurality of circuits in the signal processing unit 5 shown in FIG. 2. The signal processing circuit 120 has a function of outputting luminance information that shows a difference between the reset voltage and the read voltage output from the unit cell. The signal processing circuit 120 includes a sampling transistor 121 and a clamp capacitor 122 which are connected in series between the first signal output line and a second signal output line, a sampling capacitor 123 which is connected in series between the second signal output line and GND, and a clamp transistor 124 which is connected in series between the second signal output line and a reference voltage terminal (VDD in this embodiment).

The drive device 12 is roughly made up of a semiconductor device for driving/controlling the imaging device 11 by supplying control signals, and peripheral circuitry of the semiconductor device. The drive device 12 waits for an input of a photographing instruction from outside. Upon receiving a photographing instruction, the drive device 12 controls the imaging device 11 to read luminance information from all unit cells in sequence, after a lapse of an appropriate exposure time.

In detail, the drive device 12 applies a reset pulse (initialization signal RESET), a read pulse 1 (READ1), and a read pulse 2 (READ2) to the pixel circuit 110, and a sampling pulse (SP) and a clamp pulse (CP) to the signal processing circuit 120, with predetermined timings. As a result, transistors corresponding to these control pulses are opened (OFF) or closed (ON).

<Operation>

The imaging device 11 in this embodiment is a two-pixel cell type, and so performs a same operation for each pixel in one cell. A detailed operation for each pixel is similar to that of the conventional solid-state imaging device described in patent document 2.

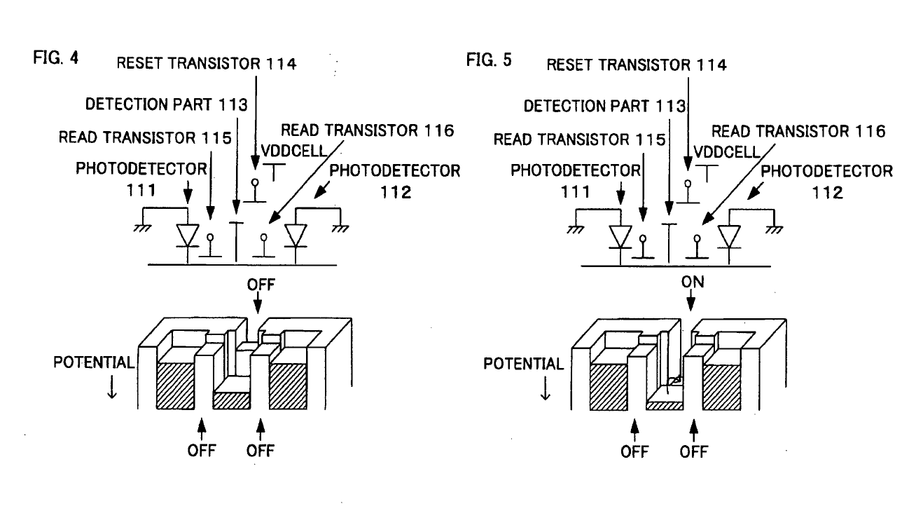

FIGS. 4 to 10 show a state of a potential in each region in the pixel circuit 110 at different timings, where incident light is not strong enough to saturate any of the photodetectors 111 and 112 (this state is hereafter referred to as a “normal state”).

In each of FIGS. 4 to 10, the upper half schematically shows a circuit corresponding to the pixel circuit 110, whilst the lower half shows a state of a potential in each region of the circuit.

In FIG. 4, charges are generated in the photodetectors 111 and 112 when the read transistors 115 and 116 and the reset transistor 114 are OFF. In the normal state, these charges do not overflow to the detection part 113.

In FIG. 5, the reset transistor 114 is turned ON while the read transistors 115 and 116 remain OFF, following the state of FIG. 4. As a result, the charges generated in the photodetectors 111 and 112 do not move to the detection part 113, but a charge in the detection part 113 moves to the VDDCELL terminal.

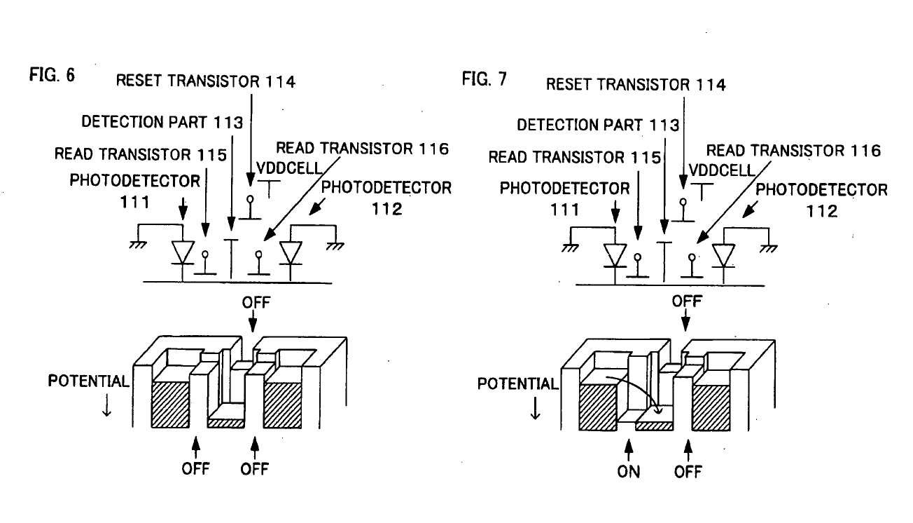

In FIG. 6, the reset transistor 114 switches from ON to OFF while a potential of the VDDCELL terminal is VDD, following the state of FIG. 5. Since the read transistors 115 and 116 and the reset transistor 114 are OFF, the voltage of the detection part 113 is reset to VDD. Also, the clamp transistor 124 is ON, and so a voltage of the second signal output line is reset to VDD.

After this, the clamp transistor 124 switches from ON to OFF, and a difference between the reset voltage and VDD is held in the clamp capacitor 122.

In FIG. 7, the read transistor 115 is turned ON while the reset transistor 114 remains OFF, following the state of FIG. 6. As a result, the charge generated in the photodetector 111 moves to the detection part 113.

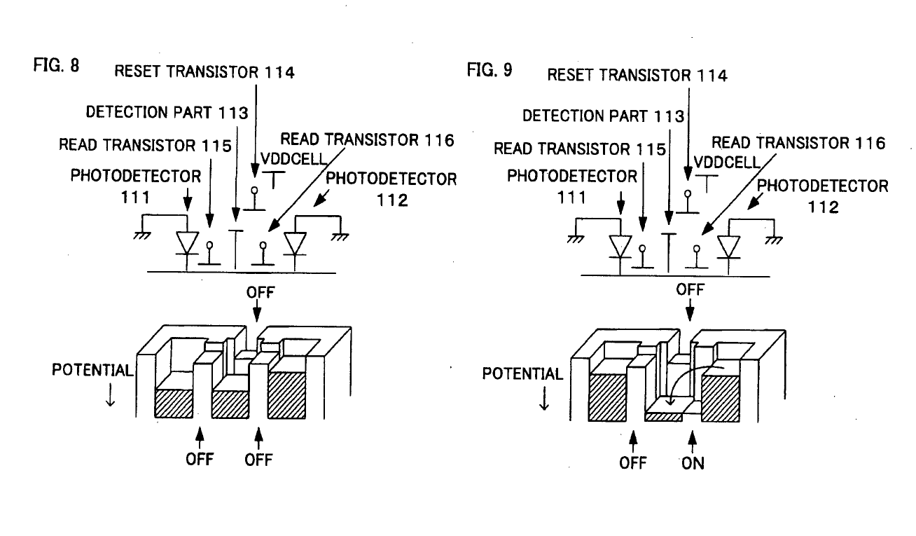

In FIG. 8, the read transistor 115 is turned OFF while the reset transistor 114 remains OFF, following the state of FIG. 7. Here, the charge generated in the photodetector 111 is obtained in the detection part 113.

Since the voltage of the detection part 113 changes and the changed voltage is amplified by the amplification transistor 117, the voltage of the first signal output line changes to the read voltage. Also, since the difference between the reset voltage and VDD is held in the clamp capacitor 122, the voltage of the second signal output line is “VDD−(the change of the voltage of the first signal output line)”. This voltage of the second signal output line is output as luminance information. Let SIG be the change of the voltage of the first signal output line, Ccp be a capacitance of the clamp capacitor 122, and Csp be a capacitance of the sampling capacitor 123. Then the voltage of the second signal output line is “VDD−SIG×Ccp/(Ccp+Csp)”.

In FIG. 9, the read transistor 116 is turned ON while the reset transistor 114 remains OFF, following the state of FIG. 6. As a result, the charge generated in the photodetector 112 moves to the detection part 113.

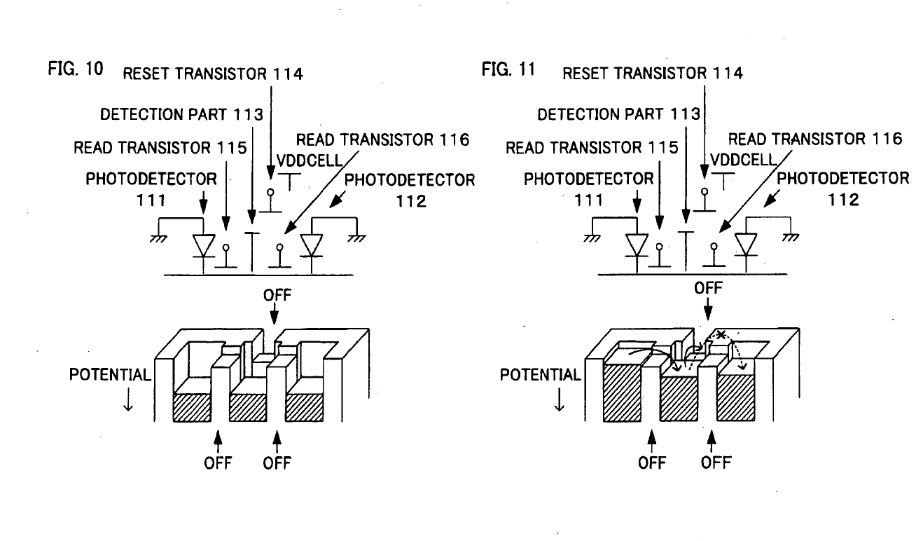

In FIG. 10, the read transistor 116 is turned OFF while the reset transistor 114 remains OFF, following the state of FIG. 9. Here, the charge generated in the photodetector 112 is obtained in the detection part 113.

The above operation is repeated for each pixel.

FIG. 11 shows a state of a potential in each region in the pixel circuit 110 at the same timing as in FIG. 4, where incident light is strong enough to saturate the photodetector 111 (hereafter this state is referred to as an “abnormal state”).

In FIG. 11, the upper half schematically shows the circuit corresponding to the pixel circuit 110, and the lower half shows a state of a potential in each region of the circuit, as in FIGS. 4 to 10.

In the abnormal state shown in FIG. 11, the charge generated in the photodetector 111 exceeds a threshold value of the read transistor 115 and overflows to the detection part 113. However, since the reset transistor 114 has a lower threshold value than the read transistor 116, the overflowing charge passes over a gate of the reset transistor 114 rather than a gate of the read transistor 116. Accordingly, the overflowing charge will not leak to the photodetector 112.

<Conclusion>

In the embodiment described above, a read transistor is realized by an enhancement transistor, and a reset transistor is realized by a depression transistor. According to this construction, even when a charge overflows to a detection part as a result that strong light falls on one photodiode and causes the photodiode to saturate, the overflowing charge is kept from leaking to another unsaturated photodiode, because the charge is drained away before a potential of the detection part reaches 0 V.

This construction is particularly useful to an imaging device without a row selection transistor, since the charge leakage can be prevented despite that a detection part of an unselected cell cannot be reset while reading a charge from a detection part of a selected cell.

This construction is also useful to an imaging device equipped with a row selection transistor, since there is no need to perform specific control such as resetting a detection part of an unselected cell using a reset transistor.

(Modifications)

Though the present invention has been described by way of the above embodiment, the present invention should not be limited to the above. One modification example is given below.

<Overview>

The modification example relates to an imaging device having a multi-pixel cell MOS image sensor in which enhancement transistors are used as a read transistor and a reset transistor and a low bias voltage is applied to a gate of the reset transistor, and a digital camera equipped with the imaging device. According to this construction, even when a charge overflows to a detection part as a result that strong light falls on one photodiode and causes the photodiode to saturate, the overflowing charge is prevented from leaking to another unsaturated photodiode, because the charge is drained away before a potential of the detection part reaches 0 V.

<Construction>

The modification example differs from the above embodiment in that the reset transistor is not a depression transistor but an enhancement transistor, and a low bias voltage is applied to a gate of the reset transistor.

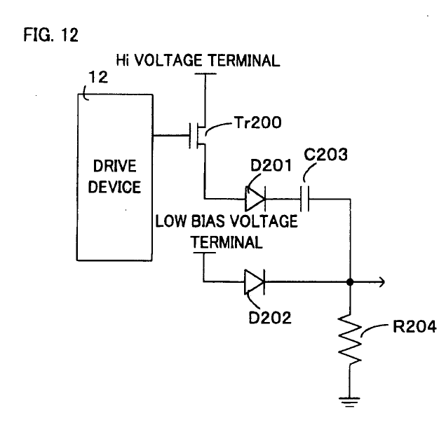

FIG. 12 schematically shows a low bias circuit which outputs the low bias voltage.

Tr200 is a switching transistor, and is turned ON when the drive device 12 outputs a Hi voltage (VDD) and OFF when the drive device 12 outputs a Lo voltage (GND).

D201 and D202 are each a diode for preventing backflow of a current, and are respectively connected with a Hi voltage terminal and a low bias voltage terminal. C203 is a capacitor for outputting only a pulse component. R204 is a grounding resistor.

<Operation>

The low bias circuit shown in FIG. 12 operates in the following manner. When the drive device 12 outputs the Hi voltage, the switching transistor Tr200 is turned ON and a Hi voltage is output from the Hi voltage terminal through the diode D201. When the drive device 12 outputs the Lo voltage, the switching transistor Tr200 is turned OFF and the low bias voltage is output from the low bias voltage terminal through the diode D202.

Though this modification example describes the case where the read transistor and the reset transistor are enhancement transistors, the present invention is not limited to this. For example, the read transistor and the reset transistor may be depression transistors. Alternatively, the read transistor and the reset transistor may be different transistors, so long as applying the low bias voltage to the gate of the reset transistor causes the charge overflowing to the detection part to be drained away before the potential of the detection part reaches 0 V.

The present invention can be applied to imaging equipment such as a video camera and a digital still camera. The present invention solves the problem of a multi-pixel cell MOS image sensor by preventing a charge, which overflows to a detection part as a result that strong light falls on one photodiode and causes the photodiode to saturate, from leaking to another unsaturated photodiode. This enables correct reading of a luminance signal, and contributes to a higher picture quality. Hence the present invention has excellent industrial applicability.

Although the present invention has been fully described by way of examples with reference to the accompanying drawings, it is to be noted that various changes and modifications will be apparent to those skilled in the art.

Therefore, unless such changes and modifications depart from the scope of the present invention, they should be construed as being included therein.

What is claimed is:

1. An imaging device including an arrangement of a plurality of unit cells each for storing luminance information corresponding to an amount of received light,
each of the plurality of unit cells comprising:
N photodiodes, N being an integer no less than 2;
a detection part;
N read transistors corresponding one-to-one to the N photodiodes, and each operable to switch between conducting and non-conducting states of a path between the corresponding photodiode and the detection part, thereby causing luminance information in the corresponding photodiode to be moved to the detection part;
a reset transistor operable to switch between conducting and non-conducting states of a path between a power supply terminal and the detection part; and
an amplification transistor operable to amplify the luminance information moved to the detection part,
wherein each of the N read transistors is an enhancement transistor, and the reset transistor is a depression transistor.

2. The imaging device of claim 1,
wherein amplification transistors of a predetermined number of unit cells are connected to one common output line, and
amplified luminance information in each of the predetermined number of unit cells is output to the common output line.

3. An imaging device including an arrangement of a plurality of unit cells each for storing luminance information corresponding to an amount of received light,
each of the plurality of unit cells comprising:
N photodiodes, N being an integer no less than 2;
a detection part;
N read transistors corresponding one-to-one to the N photodiodes, and each operable to switch between conducting and non-conducting states of a path between the corresponding photodiode and the detection part, thereby causing luminance information in the corresponding photodiode to be moved to the detection part;
a reset transistor operable to switch between conducting and non-conducting states of a path between a power supply terminal and the detection part; and
an amplification transistor operable to amplify the luminance information moved to the detection part,
wherein each of the N read transistors and the reset transistor is an enhancement transistor, and
the imaging device further includes
a bias circuit operable to apply a low bias voltage to a gate of the reset transistor.

4. The imaging device of claim 3,
wherein amplification transistors of a predetermined number of unit cells are connected to one common output line, and
amplified luminance information in each of the predetermined number of unit cells is output to the common output line.

5. A digital camera including an imaging device that includes an arrangement of a plurality of unit cells each for storing luminance information corresponding to an amount of received light,
each of the plurality of unit cells comprising:
N photodiodes, N being an integer no less than 2;
a detection part;
N read transistors corresponding one-to-one to the N photodiodes, and each operable to switch between conducting and non-conducting states of a path between the corresponding photodiode and the detection part, thereby causing luminance information in the corresponding photodiode to be moved to the detection part;
a reset transistor operable to switch between conducting and non-conducting states of a path between a power supply terminal and the detection part; and
an amplification transistor operable to amplify the luminance information moved to the detection part,
wherein each of the N read transistors is an enhancement transistor, and the reset transistor is a depression transistor.

6. The digital camera of claim 5,
wherein amplification transistors of a predetermined number of unit cells are connected to one common output line, and
amplified luminance information in each of the predetermined number of unit cells is output to the common output line.

7. A digital camera including an imaging device that includes an arrangement of a plurality of unit cells each for storing luminance information corresponding to an amount of received light,
each of the plurality of unit cells comprising:
N photodiodes, N being an integer no less than 2;
a detection part;
N read transistors corresponding one-to-one to the N photodiodes, and each operable to switch between conducting and non-conducting states of a path between the corresponding photodiode and the detection part, thereby causing luminance information in the corresponding photodiode to be moved to the detection part;
a reset transistor operable to switch between conducting and non-conducting states of a path between a power supply terminal and the detection part; and
an amplification transistor operable to amplify the luminance information moved to the detection part,
wherein each of the N read transistors and the reset transistor is an enhancement transistor, and
the imaging device further includes
a bias circuit operable to apply a low bias voltage to a gate of the reset transistor.

8. The digital camera of claim 7,
wherein amplification transistors of a predetermined number of unit cells are connected to one common output line, and
amplified luminance information in each of the predetermined number of unit cells is output to the common output line.
